(19) United States
(12) Patent Application Publication
(10) Pub. No.: US 2008/0303352 A1
(43) Pub. Date: Dec. 11, 2008

(54) AUTOMATIC CHARGING AND POWER MANAGEMENT DEVICE

(75) Inventors: Hsiang-chi Hsieh, Sindian City (TW); Chin-ching Chan, Sanchong City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/758,536

(22) Filed: Jun. 5, 2007

(51) Int. Cl. H01H 33/59; H02J 7/34

(52) U.S. Cl. 307/113; 307/139; 320/137

(57) ABSTRACT

An automatic charging and power management device includes a charging control unit and at least one power switching control unit. The charging control unit is connected to a rechargeable battery and an input power source to control the charging operation to the rechargeable battery. The input power source can be a USB-interfaced power source or a rectification transformer based power source. The power switching control unit connects the input power source and is provided with at least one power input terminal, a charging control terminal, a charging voltage terminal, a system actuation switch, a system actuation terminal, a power type terminal, and at least one power output terminal. The charging control terminal and the charging voltage terminal are connected to the charging control unit. The system actuation terminal is actuated on/off by the system actuation switch to generate a system actuation signal. The power type terminal generates an identification signal based on the type of the input power source. The charging control unit is automatically switched between charging the rechargeable battery and supplying an output power through the power output terminal in response to the status of the power input terminal, the system actuation terminal, the power type terminal, and the charging voltage terminal.

### BACKGROUND OF THE INVENTION

1. Field of the Invention

The present invention generally relates to an automatic charging and power management device, and in particular to an automatic charging and power management device applicable to a portable direct-current (DC) power supply and battery charging device with detection of type of input power source and status of system power supply.

2. The Related Arts

Portable mass data storage and data processing devices, such as portable disk drives, mobile phones, notebook computers, and personal data assistants (PDAs), must be provided with storage of DC power or a bullet-in power supply for supplying DC power thereto or for charging purposes. However, the conventional DC power supply is primarily DC battery or cells. Each of the portable devices, such as the portable disk drives, the mobile phones, notebook computers, and personal data assistants, are not compatible in power supply so that different DC batteries and chargers must be provided for different devices. This makes it difficult to carry and use these devices.

A compound charging device is conventionally available for providing power management of different batteries with charging function. However, power management for conversion between different power supplies cannot be effected by the conventional device. Further, the conventional compound charging device requires a control chip to carry out management of power control. The control chip provides management of charging circuit and power source by means of multiple sets of I/O terminals. However, the number of the I/O terminals is substantially proportional to costs of design and manufacturing of the circuit. In other words, the charging device would be more costly if a control chip set that has more I/O terminals is used. This is adverse against industrial use and economic performance for manufacturing the charging device.

Further, the conventional charging control device or compound charging device cannot automatically switch between different control functions in response to the type of the input power source to select the optimum charging and power supply operations. This often results to an exceeding electrical current for charging operation and power supply operation. For example, in case the input power source is a USB-interfaced power source that supplies a small current, when charging to a lithium battery and power supply operation are both performed, power consumption will be significantly increased and the circuit will be over-loaded, which results in damage to the operation and parts of the circuit. Thus, this causes inconvenience and troubles in the applications of the conventional charging device and the conventional compound power supply.

Taiwan Patent Publication No. 1246789 discloses a complicated, while traditional, multiple-control-terminal chip (microprocessor) for controlling a charging power source for charging a nickel-hydride/nickel-cadmium battery and emergency power management. The circuit of I/O terminals of this device is costly, which causes adverse influence on circuit design and industrial use. Further, the charging device must be manually operated through a complicated process to switch to the emergency power supply function. This makes the charging operation and the power supplying function of the device become difficult.

In addition, Taiwan Patent Publication No. 1242358 discloses a device that performs charging operation for a USB-interfaced mobile device, but its function is limited to charging only, and not available for performing input, conversion, and supply management for different power supplies. Further, the power management of the conventional device uses signals of up-stream D+ and down-stream D− of the USB interface to manage the power for charging operations. Thus, it needs a chip of more I/O control terminals and a complication circuit to realize management of power. This increases the costs of circuit design and is adverse for industrial use.

### SUMMARY OF THE INVENTION

Thus, an objective of the present invention is to provide an automatic charging and power management device, which comprises a charging control unit and a power switching control unit. The power switching control unit comprises a charging control terminal and a power output terminal. The charging control terminal is connected to the charging control unit, while the power output terminal supplies an output power. The power switching control unit automatically switches the charging control unit between a charging operation to a rechargeable battery and a power supply function through the power output terminal in response to the type of input power and power supply status on the power output terminal.

Another objective of the present invention is to provide an automatic charging and power management device comprising a power switching control unit that comprises at least a system actuation switch, a system actuation terminal, a power type terminal, and a charging voltage terminal. An actuation control signal is generated in response to the actuation on/off of the system actuation switch. The charging voltage terminal is connected to a charging control unit to obtain a charging voltage signal. The power type terminal generates an identification signal according to the type of the input power source. Power management of automatic switching between power supplying and rechargeable battery charging on the basis of the system actuation terminal, the identification signal of the input power source, and the charging voltage signal of the charging voltage terminal to realize control and management of power with the minimum control terminals.

A further objective of the present invention is to provide an automatic charging and power management device, comprising a power switching control unit that can automatically identify the type of input power source to be a USB-interfaced power source that supplies a small current or a rectification transformer based power source that supplies a large current simply through hardware terminals and then automatically switch between charging operation to a rechargeable battery and a power output supplying operation so as to completely eliminate damage of circuit or parts caused by over-loading current supplied from the input power source.

To realize the above objectives, in accordance with the present invention, an automatic charging and power management device comprises a charging control unit and at least one power switching control unit. The charging control unit is connected to a rechargeable battery and an input power source to control the charging operation to the rechargeable battery. The input power source can be a USB-interfaced power source or a rectification transformer based power source. The power switching control unit connects the input power source and is provided with at least one power input terminal, a charging control terminal, a charging voltage terminal, a system actuation switch, a system actuation terminal, a power type terminal, and at least one power output terminal. The charging control terminal and the charging voltage terminal are connected to the charging control unit. The system actuation terminal is actuated on/off by the system actuation switch to generate a system actuation signal. The power type terminal generates an identification signal based on the type of the input power source. The charging control unit is automatically switched between charging the rechargeable battery and supplying an output power through the power output terminal in response to the status of the power input terminal, the system actuation terminal, the power type terminal, and the charging voltage terminal, thereby realizing power management of automatic switching between battery charging and output power supplying in response to the type of input power source and the actuation status of system power supply in accordance with the objective of the present invention.

### BRIEF DESCRIPTION OF THE DRAWINGS

In order to clearly show and make better comprehension of these and other features and advantages of the present invention, the present invention will now be described by way of examples, with reference to preferred embodiments illustrated in the drawings, in which:

FIG. 1 shows a system block diagram of an automatic charging and power management device in accordance with a first embodiment of the present invention;

FIG. 2 shows a system block diagram of an automatic charging and power management device in accordance with a second embodiment of the present invention; and

FIG. 3 is a system block diagram showing an application of the automatic charging and power management device of the present invention.

### DETAILED DESCRIPTION OF THE PREFERRED EMBODIMENTS

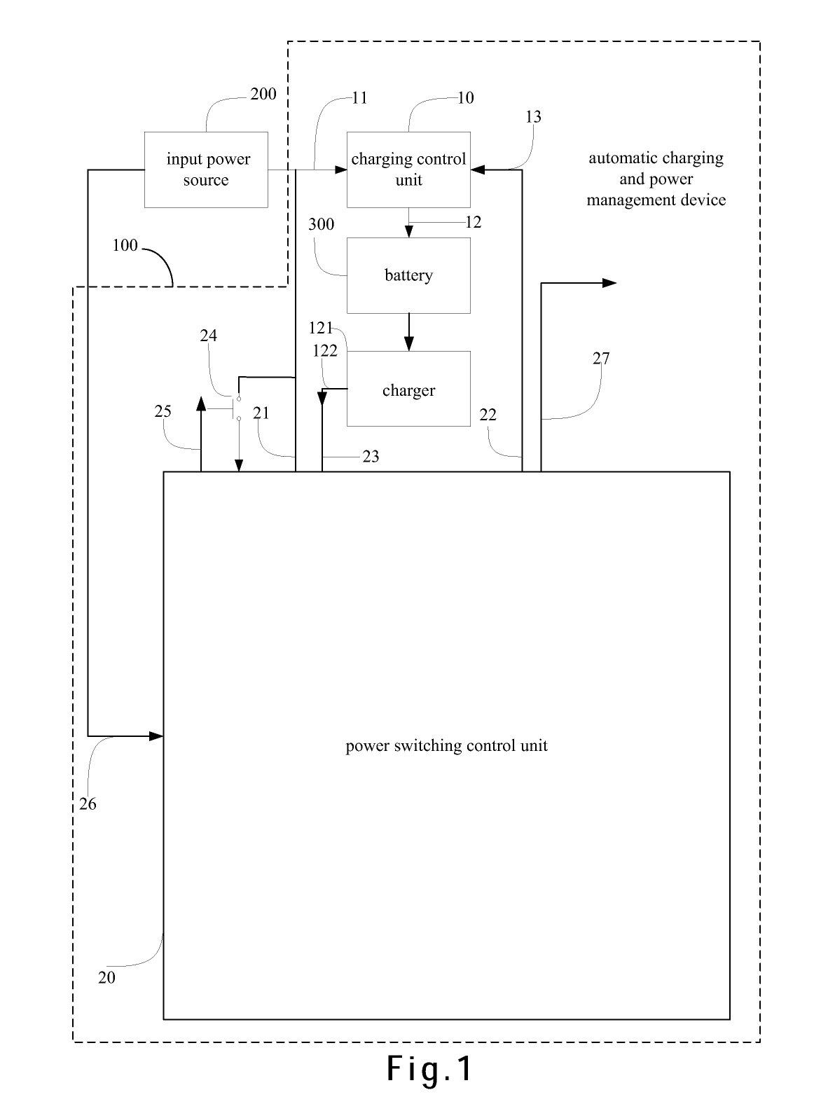

With reference to the drawings and in particular to FIG. 1, which shows an automatic charging and power management device constructed in accordance with the present invention, generally designated with reference numeral 100, the automatic charging and power management device 100 comprises a charging control unit 10 and at least one power switching control unit 20. The charging control unit 10, functioning to control charging operation, comprises a power input terminal 11, an output terminal 12, and a charging operation actuation terminal 13. The power input terminal 11 is connected to an input power source 200, which can be a direct-current (DC) power source, such as a DC power source provided by a USB-interfaced power source or a rectification transformer (AC to DC) illustrated in the embodiment of the present invention, for supplying DC power to the charging control unit 10. The output terminal 12 is coupled to a charger 121, which can be connected to a rechargeable battery 300 and has a charging status indication terminal 122, so that charging power is supplied through the output terminal 12 to the rechargeable battery 300 for proceeding with a charging operation, and the charging status thereof is output through the charging status indication terminal 122. The output at the charging status indication terminal 122 is “1” when the battery 300 is in a condition of being charged; otherwise the output is “0”. The charging operation actuation terminal 13 serves as means to selectively actuate the charging control unit 10.

The power switching control unit 20 comprises at least one power input terminal 21, a charging control terminal 22, a charging voltage terminal 23, a system actuation switch 24, a system actuation terminal 25, a power type terminal 26, and at least one power output terminal 27. The power input terminal 21 is connected to the input power source 200. The charging control terminal 22 is connected to the charging operation actuation terminal 13 of the charging control unit 10 so that the power switching control unit 20 gets control over the charging control unit 10 to proceed with a charging operation by the charging control unit 10. The charging voltage terminal 23 is connected to the charging status indication terminal 122 of the charging control unit 10 to receive the output signal ate terminal 122 representing the charging status of the rechargeable battery 300.

The system actuation switch 24 has opposite ends that are connected to the input power source 200 and the power switching control unit 20, respectively. The system actuation switch 24 can be actuated by for example depressing to make the power switching control unit 20 supplying at the system actuation terminal 25 a system actuation signal, which serves as a reference for the power switching control unit 20 two switch between power supplying or changing operation or as power output detection for the power switching control unit 20 connected to other electronic facility, such as a computer.

The power type terminal 26 is connected to the input power source 200 to generate an identification signal in accordance with the type of the input power source 200. The power type terminal 26 can identify the input power source 200 with any known manner, which can be for example a switching signal by contact. For example, the input power source 200 can be a USB-interfaced power source, with which the associated identification signal supplied to the power type terminal 26 is “0”, or alternatively, the input power source is a rectification transformer based power source, then the identification signal supplied to the power type terminal 26 is “1”.

The power output terminal 27 supplies output power from the power switching control unit 20, which is a DC power, and has a power type determined by the type of the input power source 200.

The charging control unit 10 and the power switching control unit 20 can be of any desired types. For example, they can be individual integrated circuits, or alternatively integrated together as a single integrated circuit.

In the automatic charging and power management device 100, the status of charging and power supplying of the power switching control unit 20 is listed as follows:

TABLE 1

| Power Input | Charging Voltage | Power Output |
|---|---|---|
| Terminal 21 | Terminal 23 | Terminal 27 |
| H | X | H |
| X | H | H |
| L | L | L |

TABLE 2

| Power Input | System Actuation | System Actuation |
|---|---|---|
| Terminal 21 | Switch 24 | Terminal 25 |
| X | L | X |
| H | L | L |
| H | H | H |
| L | X | L |

TABLE 3

| Input | Power | System | Power | Charging |
|---|---|---|---|---|
| Power | Output | Actuation | Type | Control |
| Source 200 | Terminal 27 | Terminal 25 | Terminal 26 | Terminal 22 |
| Rectification | H | L | H | H |
| Transformer | | | | |
| Rectification | H | H | H | H |
| Transformer | | | | |
| USB-Interfaced | H | L | L | H |
| USB-Interfaced | H | L | L | L |
| None | L | X | L | L |

Where H indicates high voltage level, L indicates low voltage level, and X means “do not care”.

Table 1 shows the relationship among the power input terminal 21, the charging voltage terminal 23, and the power output terminal 27, which shows the relationship among the outputs of the input power source 200, the rechargeable battery 300, and the power output terminal 27. Table 2 shows settings for actuating the system actuation terminal 25. Table 3 shows the relationship between different types of power source and the power output terminal 27, the system actuation terminal 25, the power type terminal 26, and the charging control terminal 22, namely the actuation signal of the system actuation terminal 25, output power from the power output terminal 27, and the control of the charging control unit 10 over the charging operation of the rechargeable battery 300.

Table 3 shows a positive logic type of high (H) voltage level actuation. However, the charging control terminal 22 can be of I/O type terminal, which allows the charging control terminal 22 to be actuated in a negative logic of low-level actuation, which is illustrated in Table 4:

TABLE 4

| Input | Power | System | Power | Charging |
|---|---|---|---|---|
| Power | Output | Actuation | Type | Control |
| Source 200 | Terminal 27 | Terminal 25 | Terminal 26 | Terminal 22 |
| Rectification | H | L | H | L |
| Transformer | | | | |
| Rectification | H | H | H | L |
| Transformer | | | | |
| USB-Interfaced | H | L | L | L |
| USB-Interfaced | H | H | L | H |
| None | L | X | L | H |

The logic contents of Tables 1-4 provides the output power of the system at the power output terminal 27 and the charging control terminal 22, as well as the associated charging conditions of the rechargeable battery 300. The power switching control unit 20 can perform power supplying, charging, or simultaneous power supplying and charging based on the system actuation status indicated by the system actuation terminal 25, power type indicated by the power type terminal 26, which in the embodiment illustrated, can be a rectification transformer type power source or a USB-interfaced power source, and the charging status of the rechargeable battery 300 indicated by the power input terminal 21 and the charging voltage terminal 23.

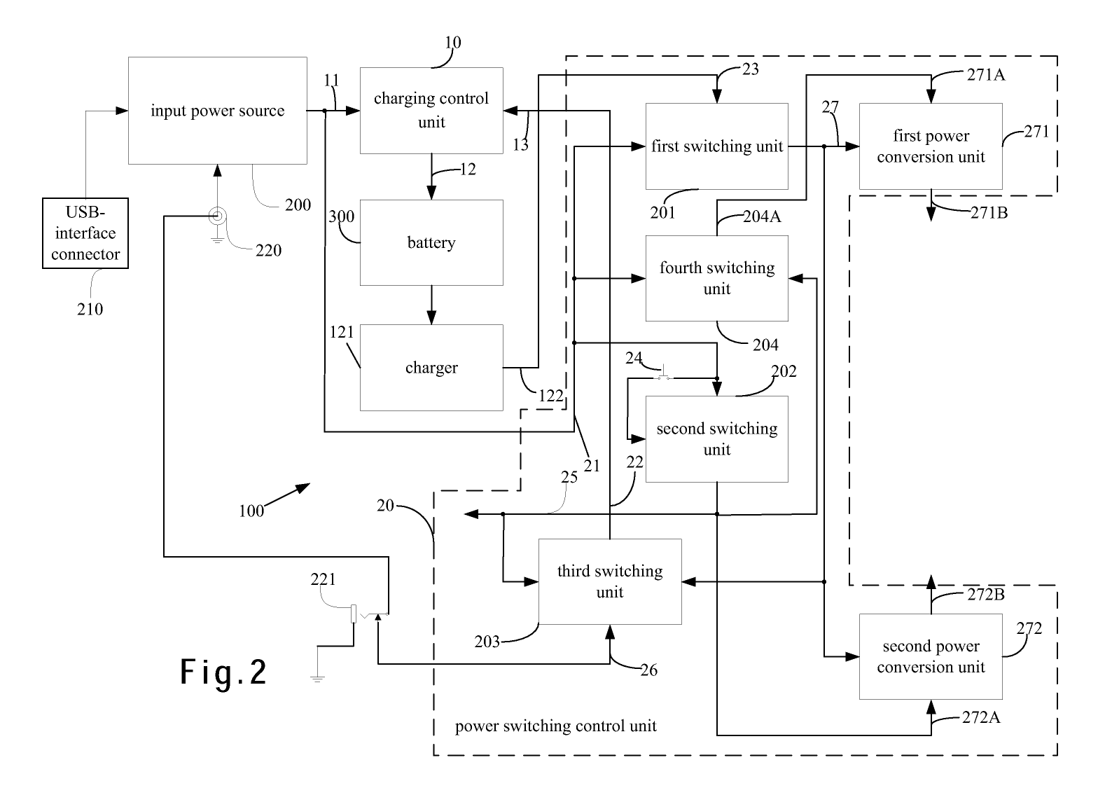

Also referring to FIG. 2, which shows a second embodiment of the automatic charging and power management device 100, the device 100 comprises a power switching control unit 20 comprising a first switching unit 201, a second switching unit 202, a third switching unit 203, and a fourth switching unit 204. The first switching unit 201 is connected to the power input terminal 21, the charging voltage terminal 23, and the power output terminal 27 to provide switching among the input power source 200, the rechargeable battery 300, and the output power of the power output terminal 27. In other words, either one of the input power source 200 and the rechargeable battery 300 can provide power to the power output terminal 27.

The second switching unit 202 is connected to the power input terminal 21, the system actuation switch 24, and the system actuation terminal 25 to perform switching among the power input terminal 21, the system actuation switch 24, and the system actuation terminal 25 to generate a system actuation signal for setting the system actuation terminal 25.

The third switching unit 203 is connected to the charging control terminal 22, the system actuation terminal 25, the power type terminal 26, and the power output terminal 27 to perform switching of the charging control terminal 22 in response to the system actuation terminal 25, the power type terminal 26, and the power output terminal 27. In other words, switching is performed over the charging control terminal 22 in response to the output power, the type of the input power source 200 indicated by the power type terminal 26, and the system actuation signal indicated by the system actuation terminal 25.

The fourth switching unit 204 is connected to the power input terminal 21 and the system actuation terminal 25, and the fourth switching unit 204 is provided with a power actuation terminal 204A. The logic status table among the power input terminal 21, the system actuation terminal 25, and the power actuation terminal 204A is shown in Table 5 as follows:

TABLE 5

| Power Input | System Actuation | Power Actuation |
|---|---|---|
| Terminal 21 | Terminal 25 | Terminal 204A |
| H | X | H |
| X | H | H |
| L | L | L |

Table 5 shows that either one of the system actuation terminal 25 and the power input terminal 21 is of high level (H), the power actuation terminal 204A is switched to high level for outputting power.

The input power source 200 comprises a USB-interface connector 210 and a rectification transformer receptacle 220 for connection with a USB-interfaced power source and a rectification transformer power source, respectively. The rectification transformer receptacle 220 is further connected to a receptacle switch 221, which is connected to the power type terminal 26 for designating the input power source 200 as a rectification transformer type power source.

FIG. 2 also shows that the power output terminal 27 is connected to the first power conversion unit 271 and a second power conversion unit 272 so that the power supplied from the power output terminal 27 can be selectively converted by the first and second power conversion units 271, 272 into first output power 271A and second output power 272A of different voltages, such as 3.6V for the first output power 271A and 5V for the second output power 272A. The first and second power conversion units 271, 272 are respectively coupled to first and second control terminals 271B, 272B. The first control terminal 271B is connected to the power actuation terminal 204A of the fourth switching unit 204 whereby the first power conversion unit 271 is controlled on/off by the logic contents listed in Table 5 to supply or cut off the first output power 271A. The second control terminal 272B is connected to the system actuation terminal 25 of the second switching unit 202 whereby the second power conversion unit 272 is controlled on/off by the logic contents listed in Table 3 to supply or cut off the second output power 272A.

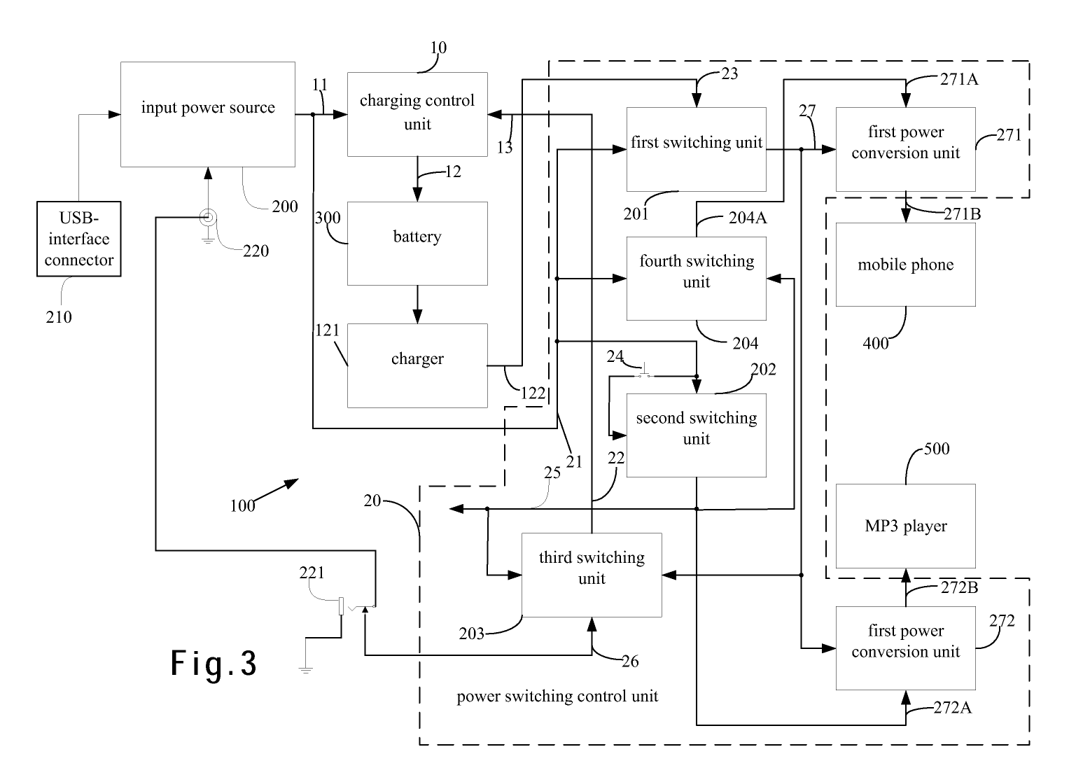

Referring now to FIG. 3, which shows an application of the automatic charging and power management device 100 in accordance with the present invention, the first output power 271A is connected to a mobile phone 400 for supplying power thereto, while the second output power 272A is connected to a MP3 player 500 to supply power thereto. The supply of power from the first and second power conversion units 271, 272 is automatically switched, based on the logic contents listed in Tables 104.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An automatic charging and power management device, comprising:
a charging control unit having a power input terminal, a power output terminal, and a charging operation actuation terminal, the power input terminal being connectable to an input power source, the power output terminal being connectable to a rechargeable battery to perform charging operation to the rechargeable battery;
at least one power switching control unit, comprising at least one power input terminal, a charging control terminal, a charging voltage terminal, a system actuation switch, a system actuation terminal, a power type terminal, and at least one power output terminal, the power input terminal being connected to the input power source, the charging control terminal being connected to the charging operation actuation terminal of the charging control unit to control actuation of charging operation of the charging control unit, he charging voltage terminal being connected to the rechargeable battery that is connected to the charging control unit to receive a status of the rechargeable battery, the system actuation switch being triggerable to generate a system actuation signal to the system actuation terminal, the power type terminal being connected to the input power source to generate an identification signal in accordance with type of the input power source, the power output terminal supplying an output power from the power switching control unit, whereby the charging control unit is switched between a charging function for charging the rechargeable battery and a power supplying condition for supplying power for power output at the power output terminal on the basis of status of the power input terminal, the system actuation terminal, the power type terminal, and the charging voltage terminal.

2. The automatic charging and power management device as claimed in claim 1, wherein the input power source comprises a USB-interfaced power source to which the power input terminal of the charging control unit is connectable.

3. The automatic charging and power management device as claimed in claim 1, wherein the input power source comprises a rectification transformer based power source to which the power input terminal of the charging control unit is connectable.

4. The automatic charging and power management device as claimed in claim 1, wherein the power output terminal of the charging control unit is connected to a charger for selectively coupling to the rechargeable battery.

5. The automatic charging and power management device as claimed in claim 4, wherein the charger comprises a charging status indication terminal.

6. The automatic charging and power management device as claimed in claim 1, wherein the charging control unit comprises an individual integrated circuit.

7. The automatic charging and power management device as claimed in claim 1, wherein the power switching control unit comprises an individual integrated circuit.

8. The automatic charging and power management device as claimed in claim 1, wherein the power switching control unit comprises:
a first switching unit connected to the power input terminal of the power switching control unit, the charging voltage terminal, and power output terminal of the power switching control unit to switch connection among the power input terminal, the charging voltage terminal, and the power output terminal;
a second switching unit connected to the power input terminal of the power switching control unit, the system actuation switch, and the system actuation terminal to switch among the power input terminal, the system actuation switch, and the system actuation terminal to selectively generate a system actuation signal for setting the system actuation terminal;
a third switching unit connected to the charging control terminal, the system actuation terminal, the power type terminal, and the power output terminal of the power switching control unit to switch among the system actuation terminal, the power type terminal, the power output terminal and the charging control terminal for performing switching of the charging control terminal in response to the output power, the power type indicated by the power type terminal, the system actuation signal indicated by the system actuation terminal; and
a fourth switching unit connected to the power input terminal and the system actuation terminal, the fourth switching unit being provided with a power actuation terminal for switching among the system input terminal, the system actuation terminal, and the power actuation terminal.

9. The automatic charging and power management device as claimed in claim 1, wherein the power type terminal is connected to a receptacle switch.

10. The automatic charging and power management device as claimed in claim 1, wherein the power output terminal is connected to a first power conversion unit and a second power conversion unit.

11. The automatic charging and power management device as claimed in claim 10, wherein the first power conversion unit supplies a first output power.

12. The automatic charging and power management device as claimed in claim 10, wherein the first power conversion unit is provided with a first control terminal.

13. The automatic charging and power management device as claimed in claim 10, wherein the second power conversion unit supplies a second output power.

14. The automatic charging and power management device as claimed in claim 10, wherein the second power conversion unit is provided with a second control terminal.
